(19) United States
(12) Patent Application Publication
(10) Pub. No.: US 2012/0145208 A1
(43) Pub. Date: Jun. 14, 2012

(54) TARP WITH PLIABLE FRAME

(76) Inventor: Eric W. HUBER, San Juan Capistrano, CA (US)

(21) Appl. No.: 13/323,805

(22) Filed: Dec. 12, 2011

Related U.S. Application Data
(60) Provisional application No. 61/459,533, filed on Dec. 13, 2010.

(51) Int. Cl. E04H 15/34; B60J 11/00

(52) U.S. Cl. 135/121

(57) ABSTRACT

A tarp includes a frame and a cover. The frame includes a grid comprised of at least three repositionable semi-rigid members extending in a first direction and at least three repositionable semi-rigid members extending in a second direction. At least one of the members extending in the second direction overlaps at least one of the members extending in the first direction. The cover, produced from a flexible sheet material, extends across the frame.

### CROSS-REFERENCE TO RELATED APPLICATION

The present application is a U.S. nonprovisional patent application of, and claims priority under 35 U.S.C. §119(e) to, U.S. provisional patent application Ser. No. 61/459,533, filed Dec. 13, 2010, which provisional patent application is incorporated by reference herein.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE PRESENT INVENTION

1. Field of the Present Invention

The present invention relates generally to tarps and other flexible covers, and, in particular, to tarps adapted to retain their position, shape and/or arrangement when placed over or under various objects and materials.

2. Background

Tarps are well known in a wide variety of applications. General purpose tarps are often used to cover objects to protect them from weather and the like, to line the interior of a vehicle to protect vehicle surfaces from objects or materials transported therein, to protect a floor or ground surface from objects or materials placed thereon, to provide a means of carrying leaves, dirt, and other materials, and the like.

In many applications, however, it can be difficult to keep the tarp in place without external means in the form of human or mechanical restraint. For example, when used to cover a pile of dirt, or to cover the contents of the bed of a pick-up truck, the cover may be blown off by the wind. When used to line the interior of a vehicle, it may be difficult to prop the edges of the tarp upward against the walls thereof. When used to cover the ground beneath a pile of dirt (so as to protect the surface beneath), the dirt may tend to fall off the flat edges.

Although rocks or heavy objects may be used to weight a tarp down when used as a cover, or ropes or ties may be used to hold it in place, such means are frequently inconvenient. Thus, a need exists for a tarp that may be reliably positioned and held in place without such external means.

### SUMMARY OF THE PRESENT INVENTION

The present invention comprises a tarp with a repositionable semi-rigid frame and a cover extending across the frame.

Broadly defined, the present invention according to some aspects is a tarp including: a frame that has a grid comprised of at least three repositionable semi-rigid members extending in a first direction and at least three repositionable semi-rigid members extending in a second direction such that at least one of the members extending in the second direction overlaps at least one of the members extending in the first direction; and a cover, comprising a flexible sheet material, extending across the frame.

The repositionable semi-rigid members may be adapted to be bent manually by a user so as to conform the cover to one or more surfaces being covered and then to retain the cover in place against outside forces until further bent by a user.

At least one of the repositionable semi-rigid members extending in the first direction and at least one of the repositionable semi-rigid members extending in the second direction may be at least partially disposed in a central region of the cover.

The grid may include at least five repositionable semi-rigid members extending in the first direction and at least five repositionable semi-rigid members extending in the second direction. Further, the repositionable semi-rigid members of the grid may be evenly spaced from one another; and the cover may be generally rectangular, and when the cover is placed in a planar configuration, the repositionable semi-rigid members are parallel and perpendicular relative to the edges of the cover.

The repositionable semi-rigid members that extend in the first direction may be separate structures from the repositionable semi-rigid members that extend in the second direction.

The repositionable semi-rigid members that extend in the first direction may be integral with the repositionable semi-rigid members that extend in the second direction.

The repositionable semi-rigid members may be comprised of metal wires.

The repositionable semi-rigid members may be comprised of metal strips.

Broadly defined, the present invention according to some aspects is a tarp including: a cover, comprising at least two layers of flexible sheet material, at least one of whose peripheral edges defines at least a portion of a perimeter thereof; and a repositionable semi-rigid perimeter frame disposed at least partially between the two layers of flexible sheet material and arranged around the entire perimeter of the cover.

The repositionable semi-rigid frame may be adapted to be bent manually by a user so as to conform the cover to one or more surfaces being covered and then to retain the cover in place against outside forces until further bent by a user.

The tarp may further include at least two additional repositionable semi-rigid frame members that extend from the perimeter frame across, and intersect in, a central region of the cover. Further, at least two additional repositionable semi-rigid frame members may include at least three repositionable semi-rigid members extending in a first direction and at least three repositionable semi-rigid members extending in a second direction, and the repositionable semi-rigid frame members that extend in the first direction may overlap the repositionable semi-rigid frame members that extend in the second direction; and the two layers of the cover may be attached to each other at various points throughout the central region of the cover.

Broadly defined, the present invention according to some aspects is a tarp including: a cover comprising a flexible sheet material whose peripheral edges collectively define a perimeter thereof; and a repositionable semi-rigid frame that includes a perimeter frame extending continuously around the entire perimeter of the cover.

The repositionable semi-rigid frame may be adapted to be bent manually by a user so as to conform the cover to one or more surfaces being covered and then to retain the cover in place against outside forces until further bent by a user.

The frame may further include at least two repositionable semi-rigid frame members that extend from the perimeter frame across, and intersect in, a central region of the cover.

The frame may further include at least one repositionable semi-rigid frame member that is physically connected directly to the perimeter frame and extends from the perimeter frame across a central region of the cover.

The cover may include a perimeter hem extending around the entire perimeter thereof, and wherein the perimeter frame is disposed within the perimeter hem.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is a top plan view of a tarp or other flexible cover having a pliable frame in accordance with one or more preferred embodiments of the present invention;

FIG. 2 is a fragmentary end cross-sectional view of the tarp or cover of FIG. 1, taken along line 2-2;

FIG. 3 is a top plan view of the pliable frame of FIG. 1;

FIG. 4 is a pictorial illustration of a portion of the tarp or other flexible cover of FIG. 1, shown with one layer removed so as to illustrate the pliable frame;

FIG. 5 is a pictorial illustration of the tarp of FIG. 1, shown installed over the contents of the bed of a pick-up, in accordance with one or more preferred embodiments of the present invention;

FIG. 6 is another pictorial illustration of the tarp of FIG. 5;

FIG. 7 is a pictorial illustration similar to that of FIG. 6 but shown with a portion of the tarp reconfigured into a repositioned, semi-rigid state;

FIG. 8 is an enlarged pictorial illustration of one of the grommets of the tarp of FIG. 1, shown in use;

FIG. 9 is a pictorial illustration of the tarp of FIG. 1, shown lining the interior of a vehicle in accordance with one or more preferred embodiments of the present invention;

FIG. 10 is a pictorial illustration of the tarp of FIG. 9, shown holding a pile of dirt;

FIG. 11 is a pictorial illustration of the tarp of FIG. 9, shown folded into a generally flat configuration for storage;

FIG. 12 is a pictorial illustration of the tarp of FIG. 11, shown being transported in a vehicle;

FIG. 13 is a top plan view of a tarp or other flexible cover having a pliable frame in accordance with another preferred embodiment of the present invention;

FIG. 14 is a fragmentary end cross-sectional view of the tarp or cover of FIG. 13, taken along line 14-14; and

FIG. 15 is a top plan view of an alternative pliable frame.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the aspects of the invention disclosed herein and may further incorporate only one or a plurality of the features disclosed herein. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers,” “a picnic basket having crackers without cheese,” and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, in which like numerals represent like components throughout the several views, one or more preferred embodiments of the present invention are next described. The following description of one or more preferred embodiments is merely exemplary in nature and is in no way intended to limit the invention, its implementations, or uses.

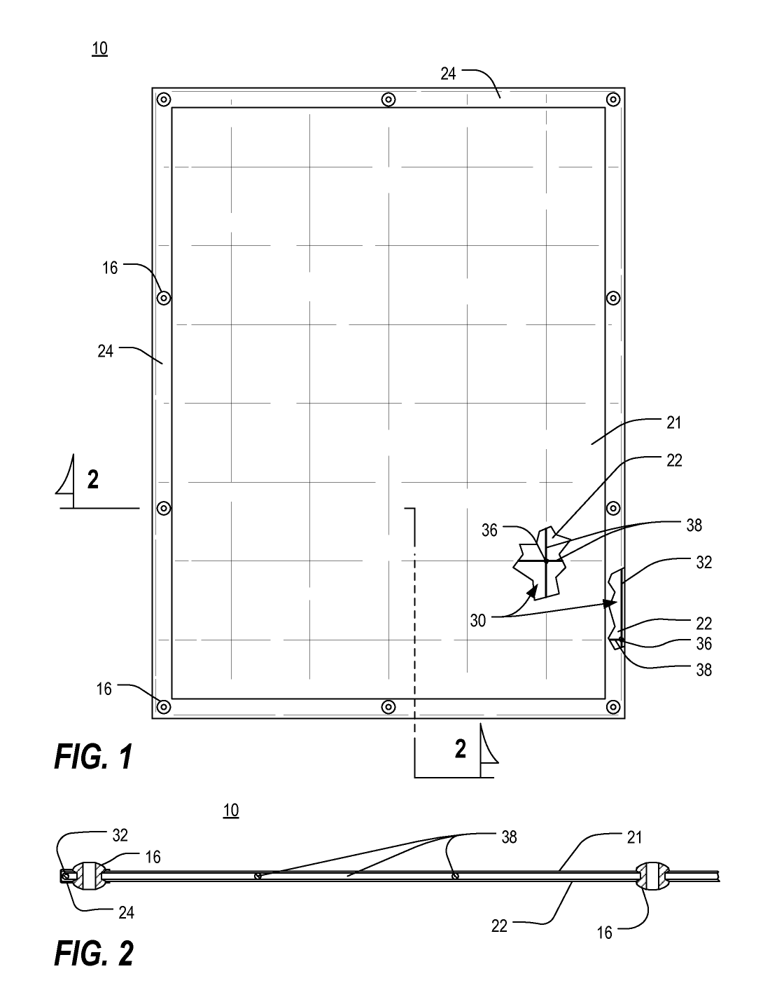

FIG. 1 is a top plan view of a tarp or other flexible cover 10 having a pliable frame 30 in accordance with one or more preferred embodiments of the present invention, and FIG. 2 is a fragmentary end cross-sectional view of the tarp or cover 10 of FIG. 1, taken along line 2-2. As shown therein, the frame 30 includes a perimeter frame 32 and a grid 38 disposed between two layers 21,22 of non-rigid sheet material conventionally used for tarps or similar covers.

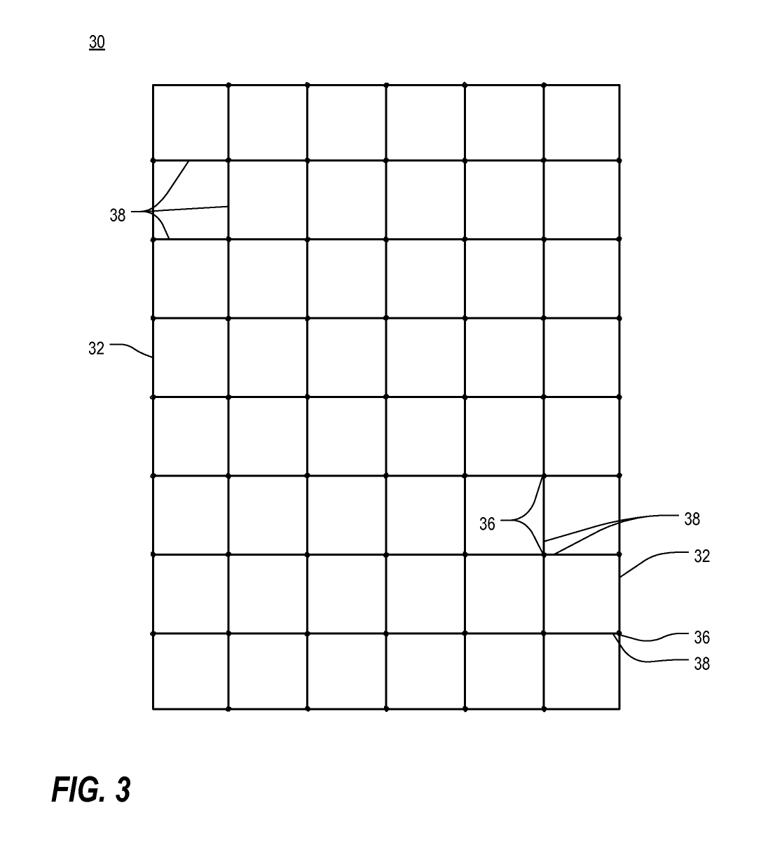

FIG. 3 is a top plan view of the pliable frame 30 of FIG. 1. The perimeter frame 32 and grid 38 are each comprised of a pliable but semi-rigid material that may be repositioned but will hold its shape against wind, gravity and other similar forces. In at least some embodiments, the material used for both components may be wire, which may be 14 gauge wire by way of non-limiting example. In at least some embodiments, the wire or other metal material is coated to resist corrosion and weathering and to protect the sheet material 21,22 from abrasion, cutting, and the like. The grid 38 may be arranged in a uniform pattern and may have a spacing that ranges from a few inches or less to a foot or more. In at least some embodiments, the pattern may be a regular grid whose members are parallel and perpendicular to the edges of a rectangular cover. In one prototype that proved suitable for at least some of the intended purposes, a spacing of one foot was used both horizontally and vertically relative to the perimeter frame 32. It will be apparent, however, that a grid having members extending in a first direction and in a second direction may, in various embodiments, utilize the same spacing between adjacent grid members in the first direction as between adjacent grid members in the second direction, or may utilize different spacings.

The two layers 21,22 of sheet material may be attached to each other around their edges so as to create an envelope in which the frame 30 is disposed. A perimeter hem 24 may be utilized to achieve this and/or to reinforce the perimeter of this envelope. As perhaps best shown in FIG. 2, the perimeter hem 24 may be created by affixing an additional strip of material around the outsides of the peripheral edges of the cover layers 21,22. Furthermore, the perimeter hem 24 may itself create a hollow channel extending around the entire periphery of the flexible cover 10 for better retaining the perimeter frame 32 therein. Materials suitable for use as the cover layers include plastic, nylon, canvas, and the like. Materials suitable for use as the perimeter hem include, but are not limited to, plastic, nylon, canvas, rubber, and the like.

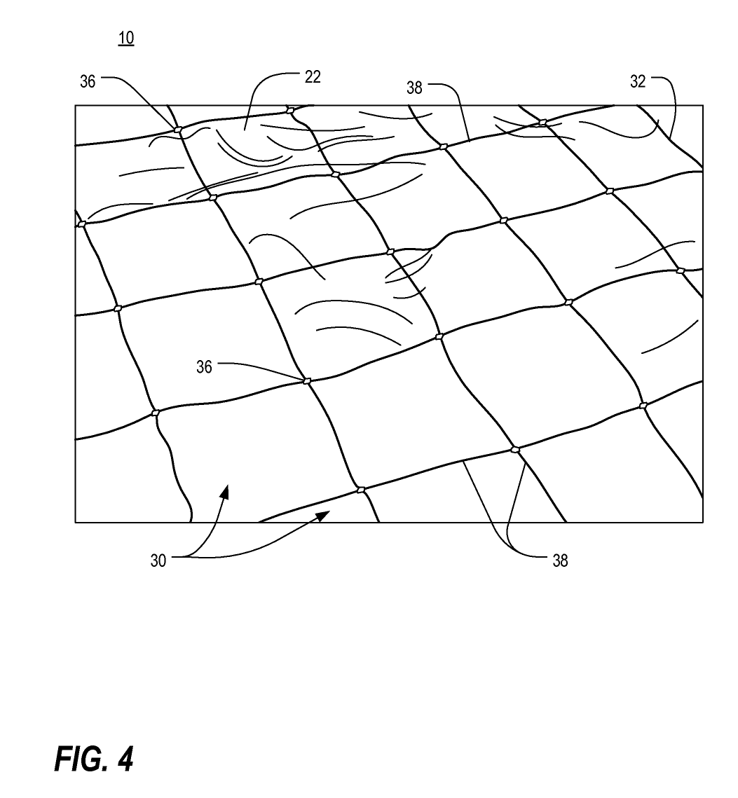

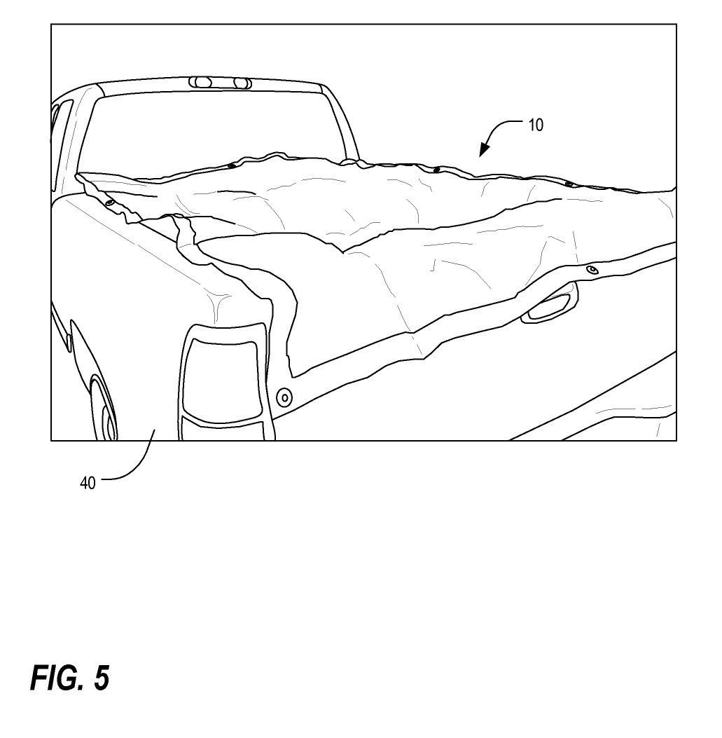

FIG. 4 is a pictorial illustration of a portion of the tarp or other flexible cover 10 of FIG. 1, shown with one layer 21 removed so as to illustrate the pliable frame 30. In this tarp 10, a one foot spacing has been used. The wires of the grid 38 may be joined at their intersections, and at their intersections with the perimeter frame, by any suitable connections means, including welding, wire or plastic wraps 36, and the like. In some embodiments, some or all of the intersections may be left unconnected, with the wires of the grid 38 kept in close proximity with one another by the material of the cover layers 21,22. Additional seams may be “quilted” to enhance such functionality. Furthermore, alternative constructions may likewise be utilized.

To cover something, the user places the tarp 10 over the contents to protect. The pliable frame 30 that is integrated into the tarp 10 between the two cover layers 21,22 gives the tarp 10 properties that keep it in place when the user folds, wraps and bends it around the contents that are to be protected.

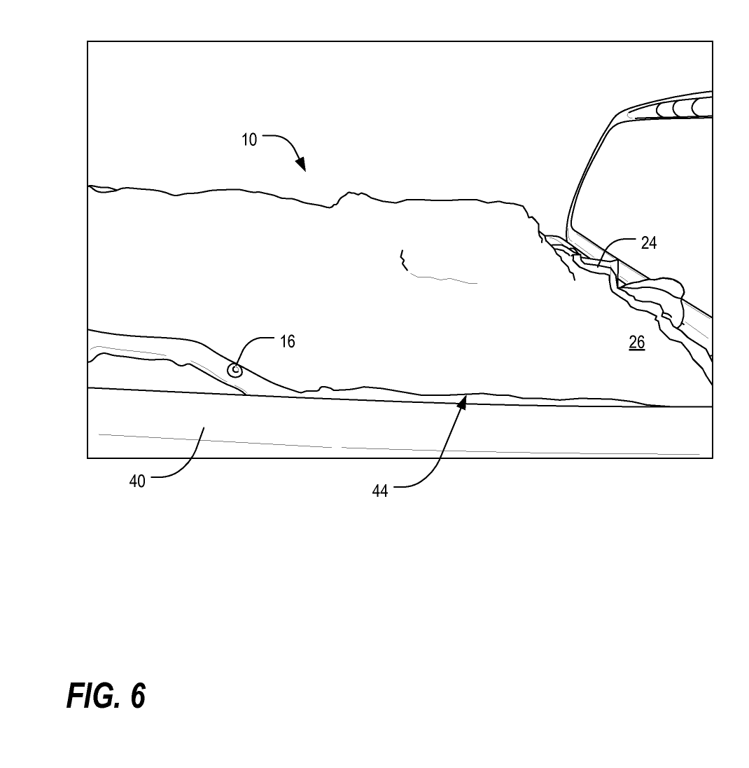

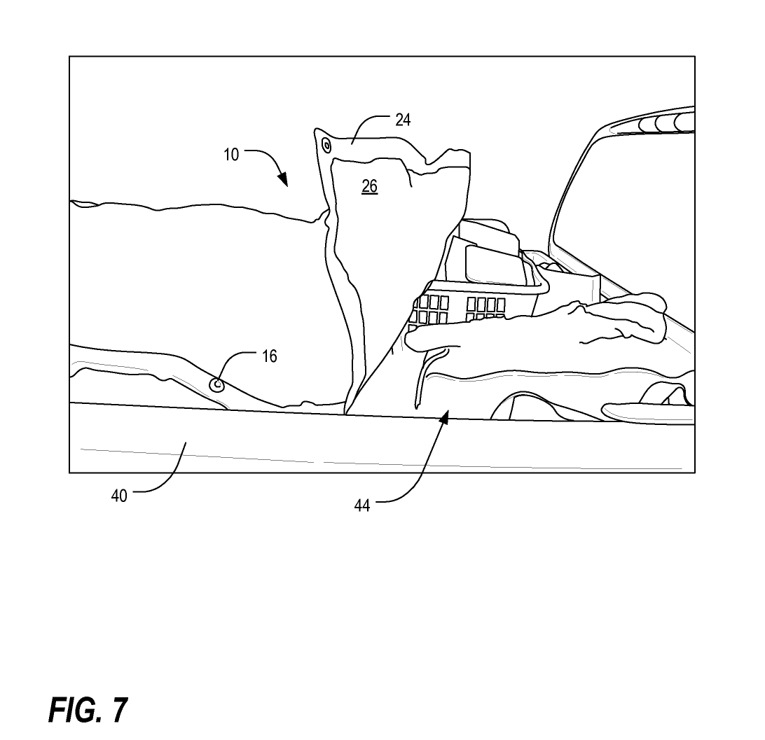

FIG. 5 is a pictorial illustration of the tarp 10 of FIG. 1, shown installed over the contents of the bed of a pick-up, in accordance with one or more preferred embodiments of the present invention. In this configuration, the tarp 10 appears to be no different than any conventional tarp, in that it is generally draped over the contents of the bed of the pick-up. However, the repositionable semi-rigid frame 30 enables the tarp 10 to retain its shape in a way that conventional tarps cannot. This is illustrated in FIG. 6, which is another pictorial illustration of the tarp of FIG. 5, and FIG. 7, which is a pictorial illustration similar to that of FIG. 6 but shown with a portion of the tarp reconfigured into a repositioned, semi-rigid state. In FIG. 6, the tarp 10 is once again draped over the contents of the bed of the pick-up, but in FIG. 7, a corner 26 of the tarp 10 has been pulled upward and back, exposing the contents 44 beneath. It will be appreciated that the corner of the tarp is standing upright of its own accord; it is not being held by hand or propped up with some separate means. Instead, the internal frame 30, once bent and otherwise reformed into a new configuration, remains in that configuration until the next reformation by the user. This has the advantage not only of making it easier, for example, to search beneath the tarp for a particular item (i.e., because the corner of the tarp remains upright without human intervention) but of facilitating “molding” the tarp 10 over the contents in such a way that the tarp 10 can be expected to stay in place, resisting the forces of wind, gravity and the like.

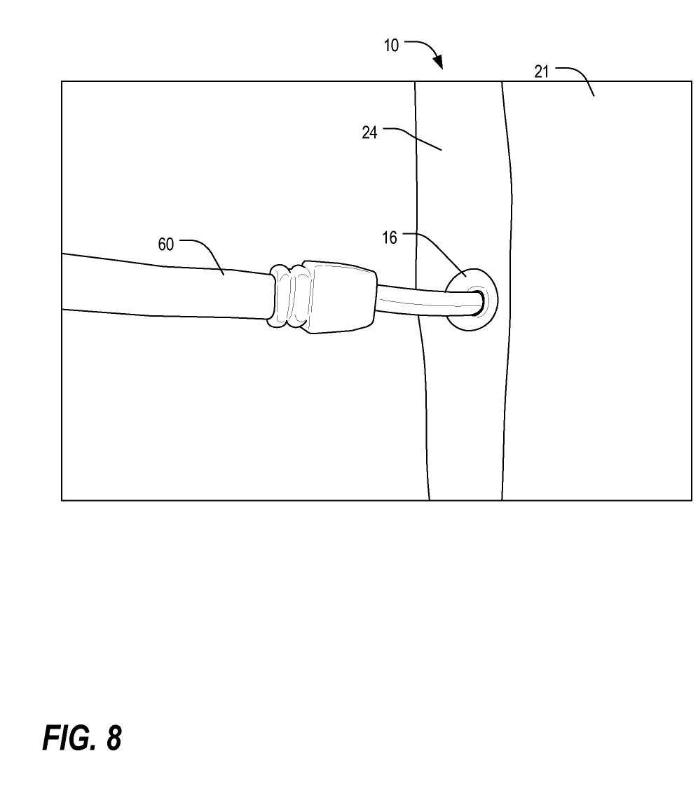

Additional assistance in this regard may be provided through the use of grommets 16 disposed in strategic locations in the tarp 10. For example, in the tarp 10 illustrated herein, grommets are spaced relatively evenly around the periphery of the tarp 10. The perimeter hem 24 and grommets 16 are preferably sized so as to ensure that the grommets 16 are disposed entirely within the body of the hem 24, as shown in FIGS. 1 and 2. This aids in reinforcing the area around the grommets 16. The grommets may be generally conventional in nature. FIG. 8 is an enlarged pictorial illustration of one of the grommets of the tarp of FIG. 1, shown in use.

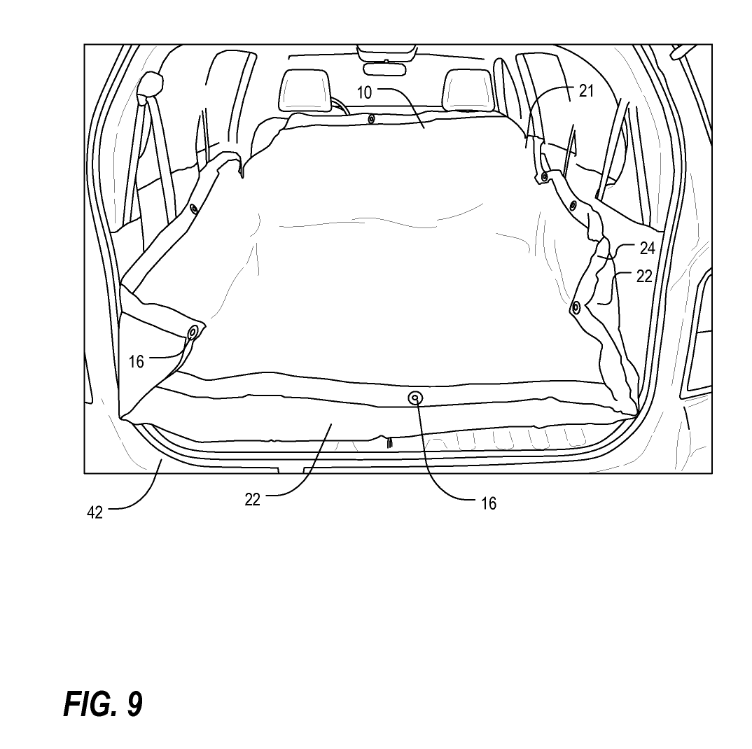

A tarp or cover 10 of the present invention may be utilized in other ways as well. For example, FIG. 9 is a pictorial illustration of the tarp of FIG. 1, shown lining the interior of a vehicle 42 in accordance with one or more preferred embodiments of the present invention. Although a conventional tarp may be used, for example, to line the floor of a vehicle, it can be difficult to ensure that the corners of the vehicle floor remain protected (because a conventional liner may shift as objects or materials are placed on it) and/or that the lower walls of the vehicle interior remain protected (because a conventional liner may be difficult to prop up against the walls). As shown in FIG. 9, however, the tarp 10 of the present invention may be reconfigured (by bending and otherwise reformed) such that peripheral portions of the tarp 10 are bent upward so as to cover the lower portions of the walls, and to remain in that configuration without external support.

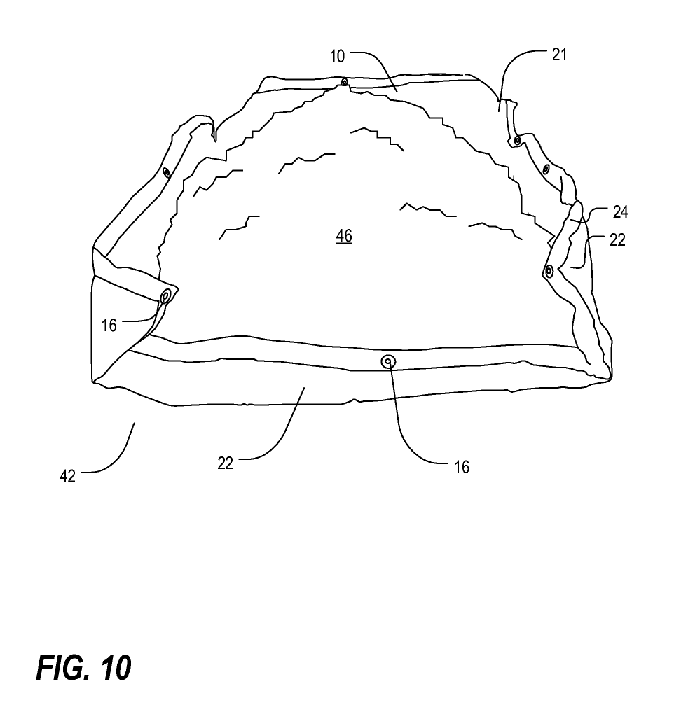

Notably, the pliable wire perimeter 32 and wire grid 38 will hold the flexible cover 10 in the configuration illustrated in FIG. 9 even without the assistance of the interior walls of the vehicle 42. FIG. 10 is a pictorial illustration of the tarp of FIG. 9, shown holding a pile of dirt 46. By bending the perimeter edge to form low walls that are generally perpendicular to the main body of the cover 10, the cover 10 may be used to contain liquid or solid components or materials, such as the pile of dirt 46 shown in FIG. 10.

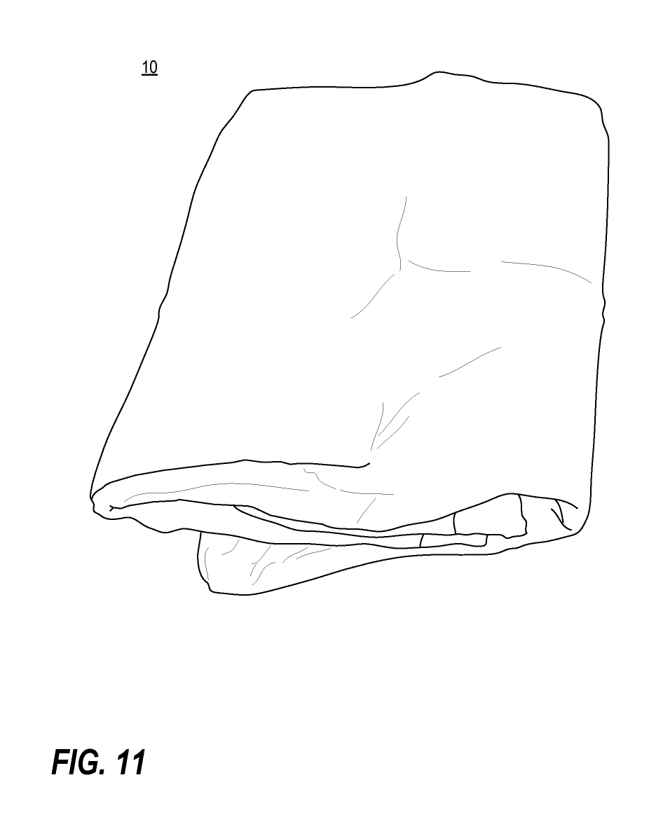

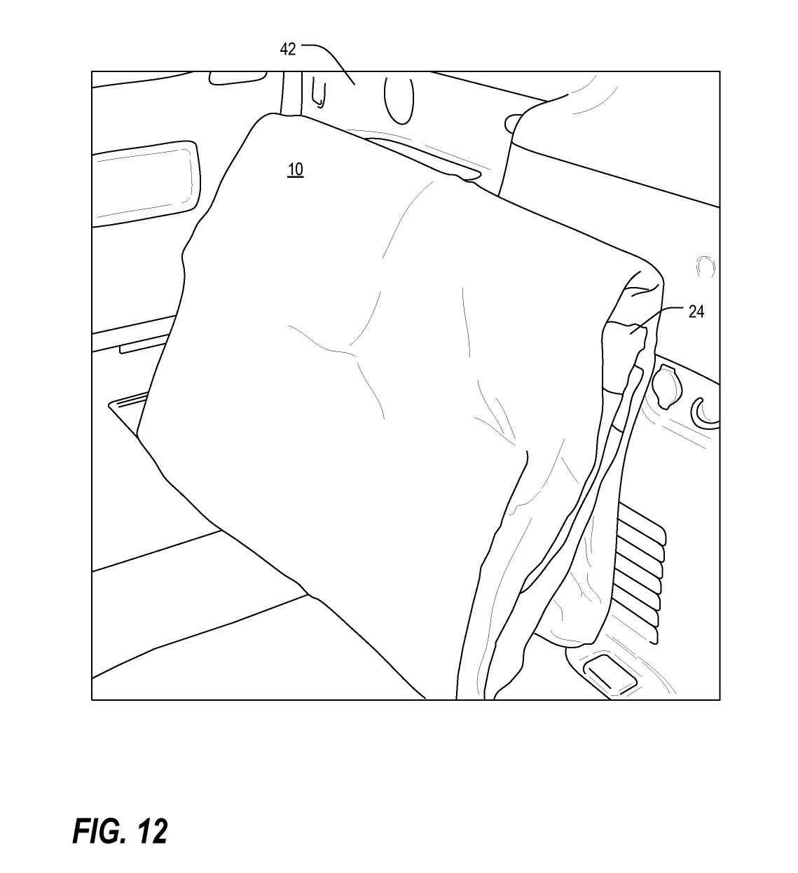

When not in use, the tarp or cover 10 may be folded and stored in a relatively flat configuration as shown in FIG. 11 or transported as shown in FIG. 12.

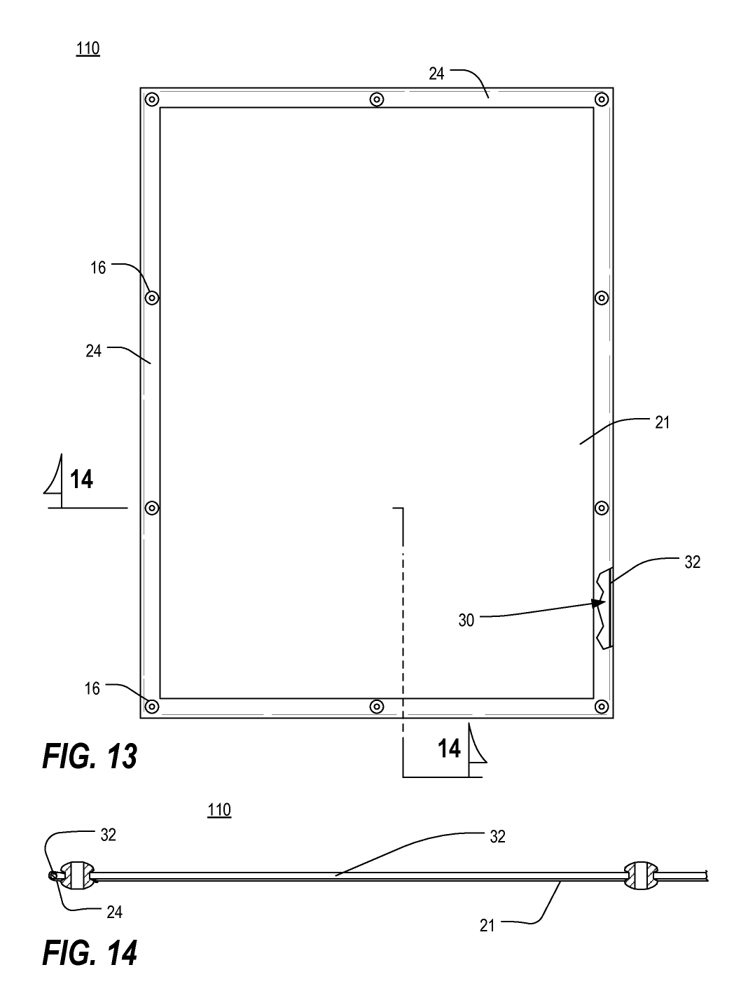

FIG. 13 is a top plan view of a tarp or other flexible cover 110 having a pliable frame 130 in accordance with another preferred embodiment of the present invention; and FIG. 14 is a fragmentary end cross-sectional view of the tarp or cover 110 of FIG. 13, taken along line 14-14. Unlike the frame 30 of the cover 10 of FIGS. 1 and 2, the frame 130 of this cover 110 may include only a perimeter frame 32 disposed within a perimeter hem 24, forming a hollow channel, that extends around the periphery of a layer 21 of non-rigid sheet material conventionally used for tarps or similar covers. In at least some embodiments, the hem 24 comprises a separate strip of material that is sewn, adhered or otherwise affixed to the cover layer 21. In other embodiments, the hem 24 is simply created from the edge of the cover layer 21, folded back on itself If a separate strip is utilized, then a different material may be used, in which case it may be preferable to use material that provides enhanced strength and durability in the region of the perimeter frame 32. Materials suitable for use as the cover layer 21 may include, but are not limited to, plastic, nylon, canvas, and the like. Materials suitable for use as the perimeter hem 24 may include, but are not limited to, plastic, nylon, canvas, rubber, and the like.

As with the previous frame 130, the perimeter frame 32 is comprised of a pliable but semi-rigid material that may be repositioned but will hold its shape against wind, gravity and other similar forces. In at least some embodiments, the material used is 14 gauge wire. In at least some embodiments, the wire or other metal material is coated to resist corrosion and weathering and to protect the sheet material 21 from abrasion, cutting, and the like.

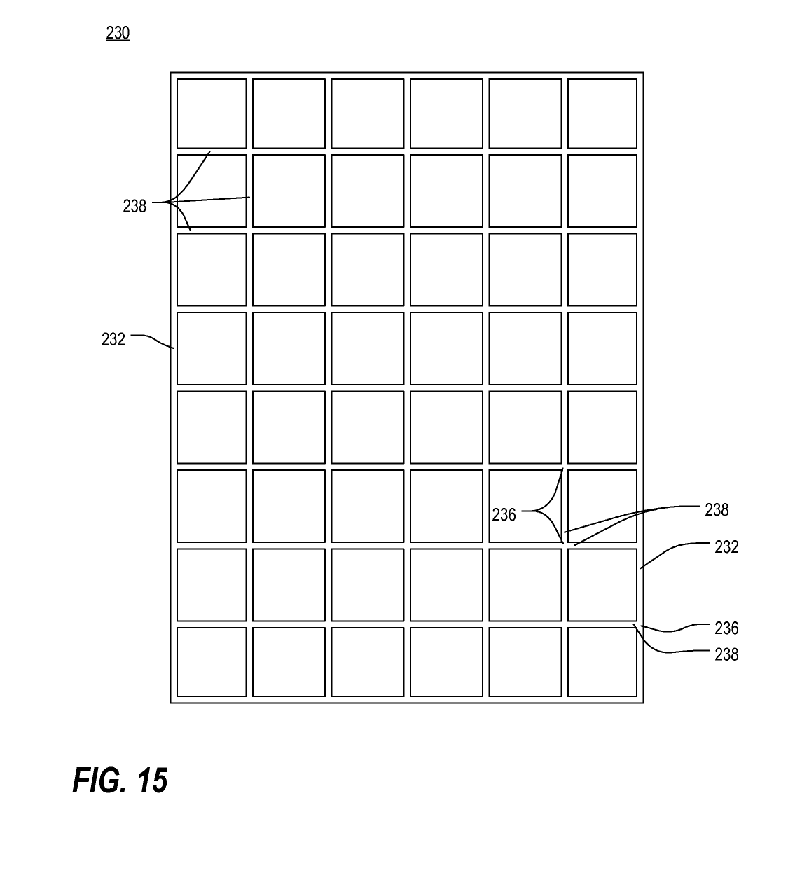

FIG. 15 is a top plan view of an alternative pliable frame 230. In this frame 230, the perimeter frame 232 and the members of the grid 238 are comprised of metal strips. As with the members of the previously-described frames 30,130, the metal strips of the alternative frame 230 are produced from a pliable but semi-rigid material that may be repositioned but will hold its shape against wind, gravity and other similar forces. The strips may be welded, riveted, bolted or otherwise fastened together at their intersections 236, or may be formed from a single metal sheet.

In at least one alternative embodiment, the cover layer or layers are comprised of a plush fabric material, and the cover is a blanket or wrap that may be placed around a user and that remains in place, “hugging” the user, without external support.

Advantageously, a tarp or cover according to one or more preferred embodiments of the present invention may hold its shape, reducing it from fluttering by wind or air resistance.

Also advantageously, a tarp or cover according to one or more preferred embodiments of the present invention may be formed into optimal shapes, such as to catch dripping water or to collect yard debris, by laying the main body of the device flat on the floor or ground and turning the perimeter edge upward 90 degrees, thereby creating a lip or low wall.

Based on the foregoing information, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof

What is claimed is:

1. A tarp comprising:
(a) a frame that includes a grid comprised of at least three repositionable semi-rigid members extending in a first direction and at least three repositionable semi-rigid members extending in a second direction such that at least one of the members extending in the second direction overlaps at least one of the members extending in the first direction; and
(b) a cover, comprising a flexible sheet material, extending across the frame.

2. The tarp of claim 1, wherein the repositionable semi-rigid members are adapted to be bent manually by a user so as to conform the cover to one or more surfaces being covered and then to retain the cover in place against outside forces until further bent by a user.

3. The tarp of claim 2, wherein at least one of the repositionable semi-rigid members extending in the first direction and at least one of the repositionable semi-rigid members extending in the second direction are at least partially disposed in a central region of the cover.

4. The tarp of claim 2, wherein the grid includes at least five repositionable semi-rigid members extending in the first direction and at least five repositionable semi-rigid members extending in the second direction.

5. The tarp of claim 4, wherein the repositionable semi-rigid members of the grid are evenly spaced from one another.

6. The tarp of claim 4, wherein the cover is generally rectangular, and wherein when the cover is placed in a planar configuration, the repositionable semi-rigid members are parallel and perpendicular relative to the edges of the cover.

7. The tarp of claim 2, wherein the repositionable semi-rigid members that extend in the first direction are separate structures from the repositionable semi-rigid members that extend in the second direction.

8. The tarp of claim 2, wherein the repositionable semi-rigid members that extend in the first direction are integral with the repositionable semi-rigid members that extend in the second direction.

9. The tarp of claim 2, wherein the repositionable semi-rigid members are comprised of metal wires.

10. The tarp of claim 2, wherein the repositionable semi-rigid members are comprised of metal strips.

11. A tarp comprising:
(a) a cover comprising at least two layers of flexible sheet material, at least one of whose peripheral edges defines at least a portion of a perimeter thereof; and
(b) a repositionable semi-rigid perimeter frame disposed at least partially between the two layers of flexible sheet material and arranged around the entire perimeter of the cover.

12. The tarp of claim 11, wherein the repositionable semi-rigid frame is adapted to be bent manually by a user so as to conform the cover to one or more surfaces being covered and then to retain the cover in place against outside forces until further bent by a user.

13. The tarp of claim 12, further comprising at least two additional repositionable semi-rigid frame members that extend from the perimeter frame across, and intersect in, a central region of the cover.

14. The tarp of claim 13, wherein the at least two additional repositionable semi-rigid frame members include at least three repositionable semi-rigid members extending in a first direction and at least three repositionable semi-rigid members extending in a second direction, and wherein the repositionable semi-rigid frame members that extend in the first direction overlap the repositionable semi-rigid frame members that extend in the second direction.

15. The tarp of claim 13, wherein the two layers of the cover are attached to each other at various points throughout the central region of the cover.

16. A tarp comprising:
(a) a cover comprising a flexible sheet material whose peripheral edges collectively define a perimeter thereof; and
(b) a repositionable semi-rigid frame that includes a perimeter frame extending continuously around the entire perimeter of the cover.

17. The tarp of claim 16, wherein the repositionable semi-rigid frame is adapted to be bent manually by a user so as to conform the cover to one or more surfaces being covered and then to retain the cover in place against outside forces until further bent by a user.

18. The tarp of claim 17, wherein the frame further includes at least two repositionable semi-rigid frame members that extend from the perimeter frame across, and intersect in, a central region of the cover.

19. The tarp of claim 17, wherein the frame further includes at least one repositionable semi-rigid frame member that is physically connected directly to the perimeter frame and extends from the perimeter frame across a central region of the cover.

20. The tarp of claim 17, wherein the cover includes a perimeter hem extending around the entire perimeter thereof, and wherein the perimeter frame is disposed within the perimeter hem.
